(19) United States
(12) Patent Application Publication
(10) Pub. No.: US 2020/0202455 A1
(43) Pub. Date: Jun. 25, 2020

(54) A personal introduction facilitation system involving personal meetings with mobile computing devices running a distributed application

(71) Applicant: David REYNOLDS, Galway (IE)

(72) Inventors: David Reynolds, Galway (IE); Edmund O'FLAHERTY, Killannin co. Galway (IE)

(21) Appl. No.: 16/639,986

(22) PCT Filed: Aug. 14, 2018
(86) PCT No.: PCT/US2018/046579

§ 371 Date: Feb. 18, 2020

Related U.S. Application Data
(60) Provisional application No. 62/547,784, filed on Aug. 19, 2017.

(51) Int. Cl. G06Q 50/00; G06Q 10/02; G06Q 30/02

(52) U.S. Cl. CPC G06Q 50/01; G06Q 30/0203; G06Q 10/02

(57) ABSTRACT

A system and distributed computing process for facilitating personal introductions relative to a social event are disclosed. One or more users who are attending or have attended a social event indicate an interest in one or more other users for a stated purposes. Such indication may take place by interacting with a profile photograph of the other user attending or who attended the social event. Only if the distributed computing process determines that two users have expressed mutual interest in one another for a matching purpose, the distributed computing process notifies both users of their common interest in each other.

### FIELD OF THE INVENTION

The field of the invention is computer-assisted dating, or alternatively computer-assisted personal introduction, or alternatively online dating.

### DESCRIPTION

Note on language use: throughout, the word “potentially” will mean “potentially, in some embodiments of this invention”.

### 1. BACKGROUND

Online personal introduction services have advantages and disadvantages. A major disadvantage is the difficulty of assessing mutual interest without personal meetings. A major advantage is that they can reduce the awkwardness associated with trying to initiate contact.

Speed-dating is useful but requires some labor to administer. Typically, a fixed number of men-seeking-women are gathered with the same number of women-seeking-men. An arrangement is made so that all meet all. Each person has a sheet on which they mark the people they are interested in seeing.

The organizer must manually process the sheets afterwards. Then the organizer must match people and put them in contact with each other. The system has advantages but also disadvantages:
1. The process requires labor from the host, in processing the results and communicating them.
2. There is potential for error on the part of the host in processing the results.
3. The process, with the need to place marks on sheets, puts physical restraints on the situation.
4. Lack of privacy: The host has access to private information, that is, knows who is interested in whom

This system puts together the advantages of online dating with the advantages of speeddating and eliminates some of the major disadvantages of both.

### 2. THIS INVENTION

Note: where something is underlined in what follows, it is being defined in the context in which it is underlined.

Definition: A Personal Introduction Event, also to be called a PI-Event: an event organized by a host in which an opportunity for personal introduction is facilitated. PI-Events will most typically be confined to times and physical places, where the customers will have a chance to meet each other, but there are also potentially virtual PI-Events, and continuous PI-Events.

Definition: There is a party known as Central Personal Introduction Service Provider (CPISP). The CPISP has a (computer) server or set of servers running a service called the CPIS (Central Personal Introduction Service). This service participates in the online administration of PI-Events.

Definition: A Personal Introduction Event Host—simply called an Event Host or host herein, a person or party organizing a PI-Event.

Note: in some embodiments the CPISP and event host could be the same party. An example could be the management of a cruise ship, which could conceivably run the CPIS on a server on the ship and therefore be the CPISP, and also be the event host. Or a host who is licensed to do both the CPISP role and the host role.

Definition: The system: The ‘system’ is the CPISP plus the Event Host, plus their computers considered in aggregate. This term will be used when we do not wish to be specific about exactly who or what in the system carries out an action.

Definition: There is a set of parties, usually individuals, known as Personal Introduction Service customers, or simply customers in this context, who will attend the PI-Event. They are seeking to make a connection with other parties at the event.

Definition: Customers-of-Potential-Interest: For every customer at a PI-Event, there is a set of Customers-of-Potential-Interest for that customer. These are the customers that this customer might be interested in connecting with. For example, for a man-seeking-women, the Customers-of-Potential-Interest for such a customer man would be the set of customer women.

Note: The host establishes a PI-Event on the server of the CPIS (for example through the CPISP's website) and makes it available to the customers for registration and attendance.

Definition: In this context, making a connection means obtaining some means to communicate privately with another customer at the PI-Event, with a known and agreed mutual intention which makes the connection make sense for both parties. In the old-fashioned way making a connection was done by telephone numbers.

Customers attending the PI-event register on that PI-Event ultimately through the CPIS, though the front-end for this could potentially be on, say, the Event Host's website if the technology is accordingly provided.

### 3. DEFINITION

### Making an Awkardness-Free Connection Request

Customers can, using the system, show an interest in making a connection with their customers of potential interest. This invention is nonspecific regarding whether this effort to make connection happens at the event or later; both embodiments are possible. But the AFCR happens on a computing device, which ultimately interacts with the CPIS.

This invention allows the ‘showing of an interest’ in making a connection with someone in a way we describe as awkwardness-free. Initiating a request for continued contact in person has disadvantages because it can be awkward for both parties, especially if rejection occurs. Rejection can be painful for the person rejected; rejection can be painful for the person rejecting; some people do not want to reject wishing not to hurt someone's feelings. Sometimes shy people will avoid making an attempt at connection.

The process of ‘showing an interest’ in making a connection with person through the system will be termed making an Awkwardness Free Connection Request (or an AFCR) towards that other person in the system.

AFCR will be an abbreviation for Awkwardness-Free Connection Request.

The system is Awkwardness-free because:

In general the connection is made only if BOTH parties request it towards each other.

If one initiating customer makes an Awkwardness-Free connection request towards another target customer and it is not reciprocated by the target customer, the target customer has no way of knowing that the initiating customer was interested in contacting them.

In a significant sense, an AFCR preserves privacy in the case of rejection for the rejected party.

If an AFCR is reciprocated, the two customers are put in contact in some way by the system. This could be, for example, by the opening of an online chat room for the two. Or it could be by sending each other each other's email address.

### 4. THE KEY PROCESS

At the event, those customers attending are exposed to
5. An opportunity to experience their customers-of-interest in some way (which could be organized individual meetings, presentations, common participation and any number of things)

They will be provided with, at least as a result of attending the event and experiencing the other customers:
6. Means to recognize what will be called designating information of another customer of potential interest, (at least in the context of the event) as applying to that customer of potential interest. Designating information of a person is an identifier of a person, at least in the context of the event.
7. An opportunity to make an AFCR towards another given customer attending the event, on a user-interface in which they select that other given customer as the specific target of their AFCR by in some way associating the designating information of that target customer with the desired AFCR, through a computer user interface which interacts ultimately with the CPIS.

The above is quite abstract, and it is helpful to give example embodiments without implying that we are confined to these sample embodiments.

If the number of people at the event is small, and the customers' eyesight good enough, a photograph could be sufficient designating information in and of itself for a person at the event. When a person goes to the event, they will see other people, determine if they are of interest, and should be able to recognize the persons of interest to them when presented their photographs alone on a user interface.

As a sample embodiment, all of those registering for the event have supplied their photograph online while registering. Either at the event (on mobile computing devices) or afterwards on some computing device, men-seeking-women would have the opportunity to see all of the photographs of women-seeking-men at that particular event on a computer user interface which is interacting with the CPIS server. (As an example, an event participant sees this information by signing into this event online through a browser which interacts with the CPIS through a website, or with the use of a specific app for interacting with the CPIS which has been provided by the CPISP). A man makes an AFCR towards a woman of interest by associating (on the user interface of the App or browser) her photograph (her designating information) with the specific AFCR he is trying to make. For example, the user interface could just show photographs and beside each, a ‘Make connection request’ button.

In a case in which there are more than a few people, photographs might not be adequate designating information. The designating information in this case could be set up to be name plus first name. A woman may have registered as “Kelly”, and provided her photograph. She will appear as the name “Kelly” with her photograph together, as designating information, available on a display of a computer user interface for men wishing to make an AFCR towards her, associated with the event. (This display can potentially be on a man's mobile computing device which he brings to the event, and he has signed into the event.) The wearing of first-name tags may be required as one of the Host's rules. Alternatively, the host could introduce people individually by first name, showcase people by first name, or they could be expected to reveal their first name when mingling. The important thing is that a customer becomes able to recognize that designating information on the user interface applies to the person at the event that they believe that it applies to.

Potentially the system makes sure that first names are unique in an embodiment such as above. If they are not, some form of disambiguation is potentially applied, such as an additional codename or initial, chosen by the system or the customer.

Not all embodiments of the system necessarily have to offer photographs as part of designating information. Designating information could be a full name alone, or code-name alone, an avatar, and going with that there potentially could or could not be name tags or tags with avatars available at the event.

The user-interface through which a customer has the opportunity to make AFCRs associated with an event does not necessarily, in all embodiments, have to PROVIDE designating information of customers of potential interest from which one is to be SELECTED by the customer as a basis for entering an AFCR. The system could require designating information to be ENTERED by the customer making the AFCR. For example, this could be used if there is a code-name only and no photograph.

Note: The designating information for a customer has meaning within that PI-Event. It may or may not contain sufficient information to designate that customer outside the context of the PI-event. So, in technical terms, designating information belongs to the namespace of the PI-Event. This does not imply of course, that the designation information is never sufficient to identify an individual out of context of the event. The only guarantee is that it IS sufficient, IN the context of the event. For example, a globally-unique codename could be exposed for each person at an event, which is globally unique through all events that the CPISP provides service for. In such a case, the CPISP could allow an initiating customer to make an AFCR towards a target customer using this globally-unique codename for this target customer, without requiring the providing the specific event context explicitly or implicitly.

### 5. PROVIDING FILTERS AND HIGHLIGHTING OF PROFILES

Potentially at the event, those signed into the event on their mobile computing devices see the designating information of all their customers-of-interest attending, and attached to the designating information about a customer, also some profile information which they have provided.

Potentially the system has provided customers with a means to express in advance to the system electronically what they are interested in finding in another person. If A is looking at the profile of B while signed into the event (while attending it or later) potentially the system organizes the profile so that matching or important information is highlighted. Potentially, some measure of the system's determination of how B′s desires in a partner are met by A can also be presented to A. (If A is a vegetarian, he may be pleased to know that B ‘likes vegetarians’.) Potentially, best matches are placed on top of the display.

### 6. RICHER AFCRS AND VARYING CONNECTIONAL PURPOSE(S)

People using a personal introduction service have a common purpose—there are reasons why they want to connect. Associated with a wish to connect is a reason to wish to connect. This is to be termed herein as a ‘connectional purpose’.

In the simplest case, there is, for example, only one available connectional purpose at a PI-Event. It could be, for example, summarized as ‘Seeking a long-term relationship’. The host determines the nature of the connectional purpose(s) at the event. Much of it will be expressed in the advertising and promotion of the event, explicitly or implicitly.

If A initiates an AFCR towards B with a particular connectional purpose, this means that it makes sense for A to contact B with this purpose in mind.

There are cases when people attending the same event have different connectional purposes for wishing to connect with others. For example, some people may wish to connect with others ‘seeking a long-term relationship’ while others will wish to connect with others ‘seeking a casual relationship’.

The system allows the event host to create on the electronic system what will be called ‘Connectional Purpose Options’. These are Options to be associated with specific connectional purposes which the Event provides for. Associated with each Option is potentially a Tag, a symbol or phrase.

Let's take a simple case: a host provides two Connectional Purpose Options on the electronic system, one summarized with the tag or phrase ‘Seeking a long-term relationship’ and another summarized with the tag or phrase ‘Seeking a casual relationship’. Likely, these options would be expressed in the promotion of the event.

If the host provides for more than one Connectional Purpose Options, there is more than one possible connectional purpose which can be associated with an AFCR through the interface. In this case, the initiator of an AFCR towards a specific person, associates that AFCR with one or more Connectional Purposes Options. (This is equivalent to making two AFCR's, each with one connectional purpose option.)

A connection will be made if and only if: both parties make an AFCR towards each other AND one or more Connectional Purpose Options MATCH. They match according to predetermined rules which apply to the Option(s). A most common rule for a Connectional Purpose Option is that it will simply and exclusively match with itself. For example, if a man selects “Seeking a long-term relationship” and a women he targets with an AFCR, sends him an AFCR with Option “Seeking a casual relationship” they will not match and they will not be connected on the basis of these selections. But if she selects “Seeking a long-term relationship” in her AFCR towards him, they will match, a connection will be established and ALL of the Connectional Purpose Options on which match occurs, and ONLY the Connectional Purpose Options on which a match has occurred, will be expressed to the customers in the connection process.

Embodiments are possible where the matching rule of connectional purpose tags is more complex. For example, ‘Seeking a submissive partner’ would potentially match only with ‘Seeking a dominant partner’.

### 7. CONDITIONAL AFCRS

The system can potentially be expanded so that the initiator of an AFCR specifies a condition for the match, which requires information about the target customer which the CPISP has but which the initiator of the AFCR does not, but which the target customer makes available on certain conditions. For example, if the target customer makes the information available under certain conditions that they belong to a certain specific religion, and an initiator of a match makes an AFCR subject to the target belonging to this same specific religion, the match is made under the conditions that these same specific religions match, and that the conditions under which the target customer made available the information that the belong to that religion were also met.

Boolean conditions are potentially available, (X OR Y) and conditions expressed by expressions are potentially available (X AND (Y OR Z)). For example

### 8. CPISP MAY PROVIDE DEFAULT CONNECTION PURPOSE OPTIONS

CPISP may potentially provide a default large set of Connection Purpose Options, host may narrow them for an event. The host would likely be able to create their own connection purpose options, and possibly rules. Some simple rules are potentially in the form simply of sets pairs which match.

### Intentionally Noncommittal Connection Purpose Option

A host could decide that a Connection Purpose Option is simply, for example, ‘Make contact’ or ‘Keep in touch’.

### 9. PI-EVENTS ARE VERY BROADLY DEFINED

A PI-Event will in the most usual case be defined as to apply in a particular place and timespan. Examples could be:
A social dance
An evening at a bar or nightclub
A day-long hike or boating trip—A cruise (which could last weeks).
An entire festival or fair
An evening at a bar for Jewish singles over 40
A college course (lasting months).

PI-Events are also potentially continuous, that is, never end. Continuous PI-events could include:
Attendance at a university (open to those attending the university currently).
Working at a specific large place of employment

There can be more than one PI-Event at a given physical event or location. For example, a particular tango festival could have a PI-Event for people under 40 and another for people over 40, which could potentially be run by different hosts.

### 10. VIRTUAL EVENTS

PI-Events could be virtual, meaning, online only. They could occur in the context of an online community or event. Associated with ‘event’ is some notion analogous to ‘attending’ and ‘participating’.

A virtual event could be associated with, for example
A podcast, and those commenting on it.
A long-term discussion or discussion area or forum
A continuous event associated with a particular Facebook Group.

### Etc.

### 11. LICENSING AND BILLING

Many variations on licensing and billing are obvious. Some interesting possibilities are:

The CPISP controls the billing for hosted events entirely—they are paid for online by the customers interacting with the CPISP, and the CPISP sends the host the host's share of the money.

Hosts control their own billing online, and must send the CPISP the CPISP's share.

Tickets for events could be provided by the system as a visual display on a mobile computing device (not unlike the way boarding passes are currently placed on mobile devices in some cases). If collecting the money, the CPISP could do this for the host and the ticket potentially has the customer's photograph on it.

### 12. INCORPORATION OF CUSTOMER'S LOCATION THROUGH GPS

For a PI-event which occurs over a significantly distributed area (for example a large-area fair or festival) GPS location of individuals (if offered by their mobile computing devices) can be incorporated so that people are shown on their mobile computing devices, the designating information of those who are physically close.

### 13. GPS LOCATION AND MONOPOLY HOST OR CONTROLLED HOSTS

GPS location can potentially be used to control the hosting of events in a geographical location. For example, at Burning Man Festival, the organizers might want to maintain the exclusive right to run (or control) PI-Events at the Burning Man Festival.

The CPISP could theoretically REQUIRE all customers using a mobile computing device at ALL events while the event is on to have their current location available to the client application on their mobile computing device. This way control of events at any particular location can be deterministically enforced at ANY location.

It is questionable whether people would be happy with their location being available to the App. However, customers can be INCENTIVIZED to allow the client app to access their location during events. By relying on the fact that some people will likely to allow this, the CPIS can be configured to receive a warning if an event is being hosted at a location in which it is not authorized.

### 14. SIGN-IN, PROFILES

Intentionally, little has been said about signing up, the setting up of profile information and signing in. This is because there are so many possible variations of this.

Note: profile information in this context can include what a person is LOOKING FOR.

Variations include:

Customers sign up on a website controlled by the CPISP, and set up a profile there.

OR Customers can sign in to Host's website and create a profile there.

CPISP's website allows Hosts to create events on CPISP's website OR Events are only created on Hosts website

OR Customer's profile in CPISP's website becomes a Default profile on the Host's website which they can modify and add items specific for the event or the mood of the day.

### 15. TRANSITION TO THE CLAIMS

A distributed application is, by definition:

The word ‘process’ when appearing alone in the claims without qualification, is intended to mean “process” as the common legal term in patent applications.

When appearing alone in this way it is not intended to be term of art in computing in general and operating systems in particular, in the phrase ‘computing process’; if that term of art meaning is intended, the term “computing process” will be used.

As a common term of art which we will follow, a computing process is an instance of a computer program that is being executed.

A Distributed application is defined as follows: A distributed applications is an application or software, a single running instance of which runs on multiple computers within a network.

We define a distributed computing process as an instance of a distributed application which is being executed.

Note that a distributed computing process is the direct analog of a computing process, but distributed over more than one computer in a network, and usually over several.

For programs which are run on a single computer, there are usually, in fact almost always, many instances of processes running that application around the world; this is certainly true of all commodity software.

We use the word ‘instance’ of a distributed application; note that there may in fact be only one such instance in the world in many cases. In contrast with applications run on a single computer, there are many significant cases of distributed applications of which there are only one running instance; the program is entirely customized for that one instance, which may have, say, a particular website front-end, and no other instance of that particular distributed application running anywhere else in the world. Therefore, sometimes, a distributed application corresponds one-to-one to a particular distributed computing process; and yet there is a distinction between the meaning of the distributed application and the distributed computing process running it even though they correspond one-to-one; the distributed computing process is running on a particular set of data, and is associated with that particular set of data while it is running. The distributed application is defined only by its software.

In what was discussed here, the CPIS is essentially a particular distributed computing process. The CPISP is the entity which owns/runs/controls the CPIS. The CPIS will be running on software, which software, taken in aggregate on both clients and servers, corresponds to a distributed application. If no other CPISP is running the same distributed application software in the world, then the CPIS is the only instance of the particular distributed application in question.

The interface of a (distributed) computing process will be regarded as the interface instance of the (distributed) application it is running. For example, the Microsoft Word application has a particular windows interface: the interface of a computing process running the Microsoft Word application will be substantially a particular window which represents the interface of that instance of the application, on the computer it is running on.

We shall use the term ‘instruct’ as follows: when a user interacts with the (distributed) computing process through its interface in a way in which the user is non-passive and is behaving in a way in which a knowing user who knows the interface would behave in order to make the (distributed) application behave in a certain way, the user is regarded as instructing the (distributed) computing process, and to behave in that particular way; a user A is regarded as instructing the (distributed) computing process to behave in the way that a knowing user B, who knows uses the interface properly, would expect it to behave, if the knowing user B behaved as user A behaved.

Therefore, for example, to click on the ‘X’ on the top right-hand corner of windows on the current Windows system is to ‘instruct’ the related computing process to terminate; to click on the square to the left is to instruct it to maximize its window. If a user intends to maximize the window, but either by clumsiness or ignorance clicks on the ‘X’, they are still for our purposes regarded as instructing the computing process to terminate; the instruction given is regarded as corresponding to the intention of a knowing user, not an unknowing one.

An instruction has ‘semantics’, which means ‘meaning’; this is a term of art from which we are in no way departing. The meaning, or semantics, of the instruction of clicking on the ‘X’ on the Windows window, is that it is to terminate.

We may use the term instruct in a way such as ‘instructs the computing process that something is so’, which is equivalent to the commanding the computing process, to note in memory, that something is so; which in turn means to make a record in memory that something is so; this is the same meaning as telling the computing process that something is so. We use ‘express’ in a way so that equivalent in meaning to ‘instructs the computing process that something is so’ is ‘expresses to the computing process that something is so’.

Following our definition of the word ‘instruct’ the phrase ‘to issue an instruction’ may be used, in the obvious way, with the instruction in question being defined in that it means exactly ‘do whatever was instructed in this case’.

When a user has a mobile computing device which has GPS or similar location system, and an application on the computing device is reading the user's location, we take the view that the user's moving around carrying the mobile computing device is an interaction with the applications interface, though it may be one which is ignored and negligible; therefore it is an interaction with the interface but it may not be a recognized instruction. Anything the user does which the application reads is an interaction of the user with the application's interface.

A distributed application can potentially have a natural-language interface, and the natural language could be entered by text or voice.

When a user is instructing an application, the user is in fact issuing a command to the application in what we call a language; not necessarily a natural or spoken language and certainly not what is known as a language to the layman; but a language nonetheless. For a user using a windows-like interface, the user is instructing the application in a kind of sign-language; the ‘utterances’ are not verbal, but they are utterances in our sense (note that defamation and libel law in certain countries similarly uses the word ‘utter’ in a similar general way which is by no means confined to spoken or natural language).

The following is a common definition of ‘language’:

language is the method of human communication, either spoken or written, consisting of the use of words in a structured and conventional way.

Ours is a little broader, but consistent with abstract and academic use:

language is the method of human communication, either spoken or written or otherwise uttered, consisting of the use of words or other utterances in a structured and conventional way.

Instructions are made by making utterances in the language of the interface.

Our use of the word ‘indicate’ should be obvious, namely, to point out, or to show.

We believe the term ‘register with’ to be a term of art, and common usage also: the meaning of ‘a first user registers with the distributed computing process, that . . . <such and such is so>’ means that the distributed computing process is given the information by the first user that <such and such is so>, and, implicitly in the context, expected to record and make use of it. There is no formal distinction between registering information with the distributed computing process and merely giving it that information, but there is a tendency for the word register to be used when the information has applicability over a nontrivial time period.

We may use the word ‘integral’ in the claims; language such as this may appear:
“and as an integral part of the process of making such an instruction, the second user indicated the third user to the distributed computing process by interacting with a profile photograph of that third user . . . .”

This is probably clear enough from common language, but just to be specific, this word ‘integral’ means here is only that without the second user indicating the third user in the manner described, the instruction would not have been a complete instruction (specifically, the distributed computing process would not know which user was the user in which interest was being expressed). This just means that that indication of the third user by the second user was non-trivial, and a necessary part of the instruction, or, put in other terms, genuinely a part of the instruction.

We would like to draw attention to the meaning of ‘only if’ in the following which may be part of a claim:
only if the distributed computing process determines that the second user has expressed such an interest in the third user, and the third user such an interest in the second user, and the first purpose matches the second purpose, the distributed computing process notifies both users of their common interest in each other.

We intentionally did not say ‘if and only if’, because it is possible that the distributed computing process must determine that additional unspecified conditions are to be met before carrying out the notifications. The distributed application is captured under our claim, if it must make the determination specified as a necessary condition for notification. It does not need to be a sufficient condition, in order for it to be captured under our claim. Of course, a distributed computing process in which such a determination is both necessary and sufficient, is also one in which it is necessary, and is captured by our claim.

The phrase ‘from memory alone’ is important in what is below:
only if the distributed computing process determines that the second user has expressed an interest in the third user, and the third user an interest in the second, and the first purpose matches the second purpose, and the distributed computing process also determines from its memory alone that the third user satisfies the condition which the second user has supplied, the distributed computing process notifies both users of their common interest in each other.

It is important that the distributed computing process does not, for example, prompt the third user for any information in order to find out if the second user's condition is satisfied; the phrase, ‘from memory alone’ makes this explicit.

We claim:

1. A process to facilitate personal introduction, carried out by a distributed computing process, characterized in that:
a first user registers with the distributed computing process, that the first user is organizing a particular social event entailing in-person meetings;
a second user who is attending or has attended the social event which was registered by the first user, instructs the distributed computing process that this second user has an interest in a third user for a first purpose, and as an integral part of the process of making such an instruction, the second user indicated the third user to the distributed computing process by interacting with a profile photograph of that third user that the distributed computing process had made available on its interface as representing a person attending or who attended the social event;
a third user who is attending or has attended the social event which was registered by the first user, issues an instruction to the distributed computing process that this third user has an interest in a second user for a second purpose, such second purpose not necessarily being distinct from the first purpose, and as an integral part of the process of making such an instruction, the third user indicated the second user to the distributed computing process by interacting with a profile photograph of that second user that the distributed computing process had made available on its interface as representing a person attending or who attended the social event;
only if the distributed computing process determines that the second user has expressed such an interest in the third user, and the third user such an interest in the second user, and the first purpose matches the second purpose, the distributed computing process notifies both users of their common interest in each other.

2. The process of claim 1 in which the second user is enabled by the interface of the distributed computing process to select one purpose from a list of purposes provided by the distributed computing process, and the distributed computing process has been provided with sufficient data and programming to be enabled to make a determination on whether any given two purposes in the list match.

3. The process of claim 2 in which the second user is enabled by the interface of the distributed computing process to issue more than one instruction to the distributed computing process, that they are interested in one particular other user, both instructions entailing an expression of distinct purposes for which the second user is interested in the other user.

4. The process of claim 1 in which the distributed computing process offers the users who have attended or are attending the social event only one purpose for which they can express interest in other users who have attended or are attending the social event.

5. A process to facilitate personal introduction, carried out by a distributed computing process, characterized in that:
A first user registers with the distributed computing process, that the first user is organizing a particular social event entailing in-person meetings;
a second user who is attending or has attended the social event which was registered by the first user, instructs the distributed computing process that this second user has an interest in a third user for a first purpose, such interest being subject to a condition supplied by the second user and applying to the third user, and as an integral part of the process of making such an instruction, the second user indicated the third user to the distributed computing process by interacting with a profile photograph of that third user that the distributed computing process had made available on its interface as representing a person attending or who attended the social event;
a third user who is attending or has attended the social event which was registered by the first user, issues an instruction to the distributed computing process that this third user has an interest in a second user for a second purpose, such second purpose not necessarily being distinct from the first purpose, and as an integral part of the process of making such an instruction, the third user indicated the second user to the distributed computing process by interacting with a profile photograph of that second user that the distributed computing process had made available on its interface as representing a person attending or who attended the social event;
only if the distributed computing process determines that the second user has expressed an interest in the third user, and the third user an interest in the second, and the first purpose matches the second purpose, and the distributed computing process also determines from its memory alone that the third user satisfies the condition which the second user has supplied, the distributed computing process notifies both users of their common interest in each other.
